(19) United States
(12) Patent Application Publication
(10) Pub. No.: US 2002/0145055 A1
(43) Pub. Date: Oct. 10, 2002

(54) Device for injecting fuel with a variable injection pressure course

(76) Inventors: Nestor Rodriguez-Amaya, Stuttgart (DE); Roger Potschin, Brackenheim (DE); Ulrich Projahn, Leonberg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/979,502

(22) PCT Filed: Mar. 20, 2001
(86) PCT No.: PCT/DE01/01060

(30) Foreign Application Priority Data
Mar. 23, 2000 (DE) 100 14 450.0

(51) Int. Cl. F02M 47/02

(52) U.S. Cl. 239/88

(57) ABSTRACT

The invention relates to a device for injecting fuel, having an injector (1) that contains a pressure chamber (13). From the pressure chamber (13), a high-pressure line (5) extends through the injector housing (2), in which a nozzle (3) is disposed that can be closed by means of a nozzle needle (4); the nozzle needle (4) is acted upon by means of a force storing means (7). Via an actuator element (11), control valves (8, 10) that are adjustable and triggerable independently of one another are provided, which communicate with one another via a coupling chamber and by way of which the injection pressure course (24) can be controlled.

### FIELD OF THE INVENTION

The invention relates to a device for injecting fuel with a variable injection pressure course, as in high-pressure injection systems that can be used to supply fuel to internal combustion engines.

### PRIOR ART

European Patent Disclosure EP 0 823 549 A2 relates to an injector assembly for injecting fuel. An armature element actuates both an outlet valve and a control needle valve that regulates the pressure in a control chamber. When the control chamber is acted upon by fuel that is at high pressure, a force that reinforces the force of a compression spring is exerted on the control part. The outlet valve and the control needle valve are controlled by way of an electromagnetic triggering via a common component. In this version known from the prior art, the control needle valve and the top side of the control needle valve are parts of a control chamber and are dimensioned such that the control needle valve is essentially pressure-balanced at all times. Because of the arrangement selected in EP 0 823 549 A2, the control part members, that is, the control part and the needle valve at the injection valve, can be triggered independently of the applicable current level; a first, lower current level is required for actuating the first control member. The needle valve is partially actuated by the mechanical coupling. Via a second, higher current level, the needle valve is fully actuated. In this prior art version, maintaining set parameters exactly is problematic.

Versions are known from the prior art in which shaping of the injection course is achieved by providing that some of the fuel volume is blown out again via a slightly opened control valve. This procedure is known by the abbreviation CCRS (for Current Controlled Rate Shaping).

Another variant, known from the prior art, for controlling the injection pressure course resides in a pressure control by way of the control valve stroke.

### SUMMARY OF THE INVENTION

In the version according to the present invention, by the advantageous, separate design of the control valves, these valves can be adjusted at reduced effort and expense in such a way that via the triggering of the control valves of the injector, the course of the injection pressure can be shaped in accordance with predetermined values. The injection-relevant parameters for the preinjection, the pressure buildup phase with the boot phase, a pressure limitation, and the diversion rate can be specified variably depending on the intended purpose. Since the boot pressure during the pressure buildup phase can be designed independently of the design of the nozzle, the pump piston diameter in the injector, and the camshaft design, the injector and pump assembly can be used for various engine designs, since the parameters relevant for the particular injection event can be preset in an injector in accordance with specific parameters, depending on the application for the particular internal combustion engine.

The disposition of the control valves side by side and the high-pressure line extending between them makes an enormously space-saving design of the injector possible. Preinjection pressures and diversion rates can be varied independently of the engine rpm and load moment, thanks to the actuator triggering of the control valves, and as a result, shaping of whatever injection pressure course is sought in a given case can be specified within wide limits. The production tolerances of the actuator piston received in the injector housing can made less stringent, so that more-favorable production of this component can be achieved.

Another advantage resulting from the version proposed by the invention is that the control valves can be returned to their respective seats counter to the springs that act on them with different pressures. As a result, sealing can be achieved, so that the pressure buildup phase (boot injection) can take place largely without loss, since leakage losses that slow down the pressure buildup are suppressed because of the sealing action at the control valve seats.

For performing the preinjection—adapted individually to the particular engine design—the first control valve is moved into its terminal position. The control of the main injection is effected by the closure of the second control valve, by way of which a pressure limitation can also be effected, such that this valve is moved into a partly open position. Some of the fuel can flow out into a reservoir, so that the pump element in the injector can be protected against excessive stress. Also as a result, higher cam speeds can be attained, and hence an increase in the pressure at relatively low rpm and relatively low load moments is also feasible.

### DRAWING

The invention will be described in further detail below in conjunction with the drawing.

Shown are:

FIG. 1, a schematic configuration of an injector with two integrated control valves;

FIG. 2, the components, shown enlarged, of the control valves, which communicate via a coupling chamber with the pressure chamber in the injector housing of the injector;

FIG. 3, a schematic illustration of the three-dimensional disposition of control valves, high-pressure lines and actuator pistons;

FIG. 4, an illustration of the sequence of triggering the actuator and control valves with the resultant course of the injection pressure; and

FIG. 5, an injector with control valves received in its housing.

### VARIANT EMBODIMENTS

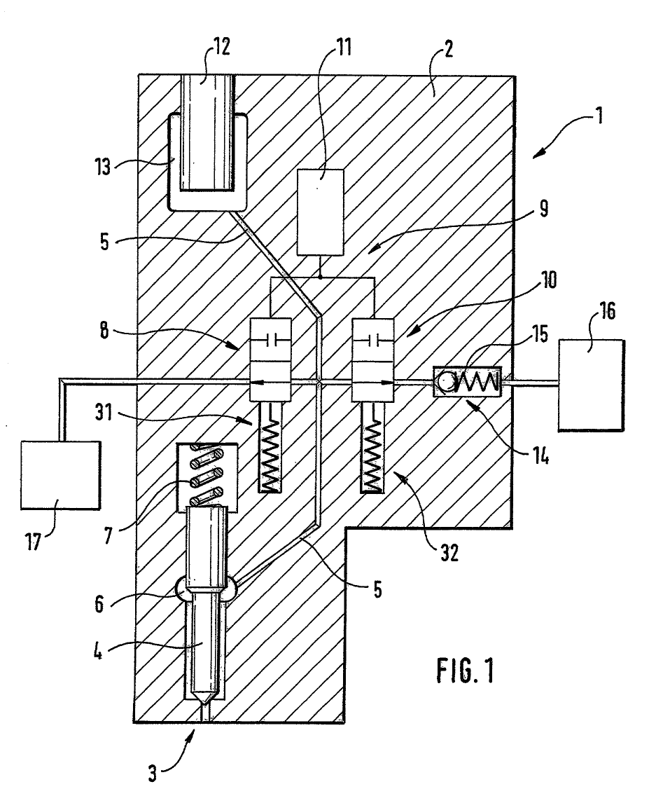

The view in FIG. 1 is a schematic illustration of an injector configuration with two control valves that are integrated with the injector housing and that can be actuated via a single actuator.

An injector 1, shown purely schematically here, includes an injector housing 2, in whose end pointing toward the engine a nozzle 3 is received. The nozzle 3 is closed by means of a nozzle needle 4, which extends from a control chamber 6. Discharging into the control chamber 6 is a high-pressure line 5, which extends through the interior of the injector housing 2 and connects the pressure chamber 13, which is acted upon by an actuator piston 12, with one another. The nozzle needle 4 is acted upon, on the end remote from the nozzle 3, by a force storing means 7. The force storing means 7—embodied for instance as a helical spring—is surrounded by the housing 2 of the injector 1.

The injection pressure control is effected by means of two control valves 8 and 10,integrated into the high-pressure supply line. The first control part 8 communicates on the low-pressure side with the second low-pressure region 17, while the second control valve communicates with a first low-pressure region 16 via an equal-pressure valve 14—or alternatively a throttle element. Via a spring element 15 or an arbitrarily otherwise-embodied adjusting element at the equal-pressure valve 14, the opening pressure in the low-pressure region 16 of the second control valve 10 can be adjusted, so that by way of this valve, the pressure load on a pressure chamber 13 is adjustable by the actuator piston 12. Via the partly opened second control valve 10, fuel can then flow out, so that the load limit for the mechanical components that are let into the interior of the injector housing 2 will not be exceeded.

The two spring elements 31 and 32 associated with the control valves 8, 10, respectively, permit the preadjustment of the actuating pressures at both control valves 8 and 10. The actuating pressures at the two control valves 8, 10 are preferably selected as relatively low, so that the control valves 8 and 10 are virtually forceless. The following relationship applies:

Stroke volume of the control valve 10<stroke volume of the control valve 8.

In the configuration schematically shown in FIG. 1, the two control valves 8 and 10 are in the open state; that is, the fuel can flow out in the direction of the arrows shown into the second low-pressure region 17 or, via the equal-pressure valve 14 if the pressure adjusted there is exceeded, into the first low-pressure region 16.

If the two control valves 8 and 10, triggered by the actuator element 11—preferably embodied as a piezoelectric actuator—move into the lower position counter to the action of the compression springs 31 and 32, respectively, then the control chamber 6 that acts on the nozzle needle 4 is made to communicate via the high-pressure line 5 with the fuel reserve, which is at maximum pressure, in the pressure chamber 13.

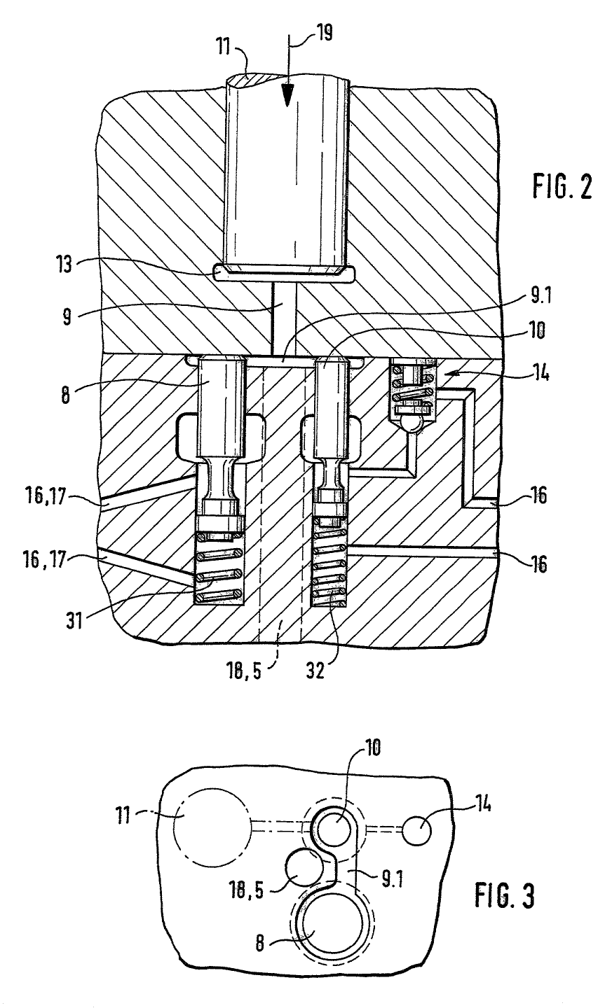

FIG. 2 in an enlarged view shows the components in the injector, which communicate with one another via a coupling chamber 9 provided in the injector housing.

Each of the control valves 8 and 10 contains a respective control part, which is preferably embodied cylindrically. The cross section of the control part of the first control valve 8, that is, the area A_{1,} is dimensioned to be greater than the cross-sectional area A₂ of the control part at the second control valve 10. Both control parts of the two control valves 8 and 10 protrude into the coupling chamber 9, upon which pressure is exerted by the actuator 11. The first control valve 8 communicates with a low-pressure region 17, in which fuel can flow out from the first control valve 8. Excess fuel flows out from the second control valve 10 into the first low-pressure region 16. Each of the two control valves 8, 10 contains force storing means 31, 33, embodied with different spring constants, with which spring forces F₁, F₂ adapted to the applicable valve function are generated.

The coupling chamber 9, the line and the coupling conduit 9.1 by way of which the control valves 8, 10 communicate with one another forms a conduit system, whose pressure relief is possible by way of a partial opening, for instance of the second control valve 10. The equal-pressure valve 14 can be disposed preceding the control valve 10, and with it the pressure of the boot phase is adjusted. The maximum allowable load pressure for the mechanical components in the injector housing 2 can then be set at the equal-pressure valve 14, which is provided in the outflow region into a reservoir, discharging for instance into the fuel tank. Between the two control valves 8 and 10, the essentially vertically extending high-pressure bore 18 is received, which carries the fuel, which is at extremely high pressure, to the nozzle 3 that protrudes from the injector housing 2 into the combustion chamber of an internal combustion engine. The three-dimensional disposition of the two control valves 8 and 10 and the course of the high-pressure bore 18 can be seen from the drawing in FIG. 3.

Via the actuator piston 11, shown in this schematic plan view, the coupling chamber 9 is formed (see FIG. 2), from which the line 9.1 that subjects the coupling chamber 9 to pressure branches off, which line can itself be considered part of the coupling chamber 9. The two piston faces of the control valves 8, 10 are shown extended inward, protruding into the coupling conduit 9.1; via the pressure chamber 13 acted upon by the piezoelectric actuator 11, they are subjected to the fuel, which is at high pressure.

The high-pressure bore 18 is disposed extending between the two control valves 8, 10 and makes an extremely compact structural shape of the injector housing 2 of the injector 1 possible. In dashed lines, the control chambers surrounding each of the control valves 8 and 10 are shown, as is the outflow line from the second control valve 10, whose piston has a smaller piston area A₂ than the piston of the first control valve 8 leading to the first low-pressure region 16.

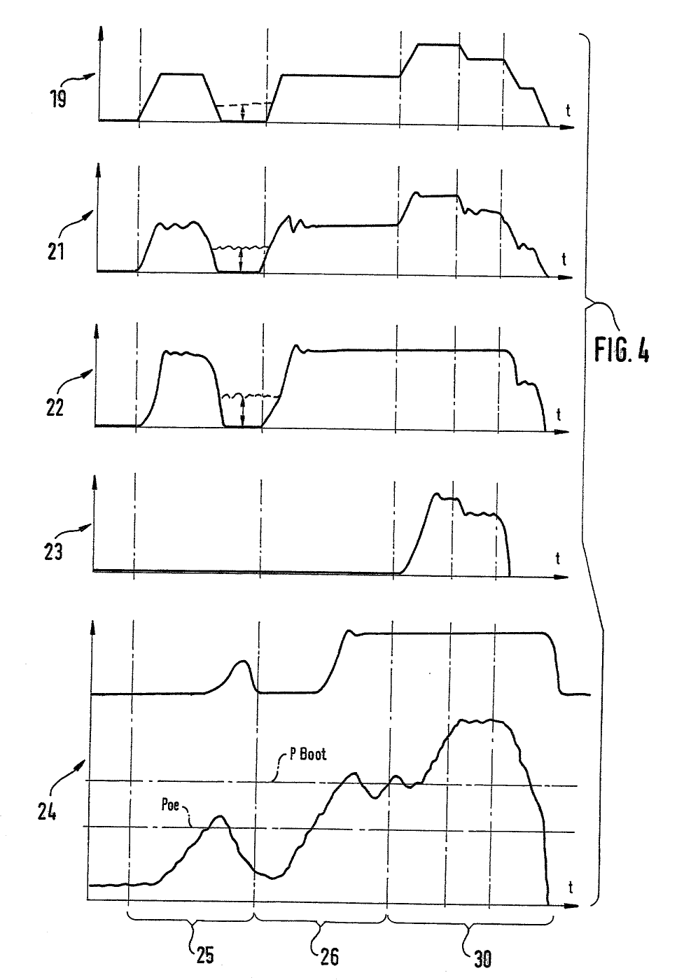

FIG. 4 shows the sequence of triggering by the actuator, that is, the various stroke motions of the control valves, plotted over time, and the resultant injection pressure course, also plotted over time.

In FIG. 4, five graphs are plotted one above the other, showing the various stroke motions, pressures and the injection pressure course generated, plotted over the time axis. The time axis can be divided up into a preinjection phase 25, a pressure buildup phase 26, and a pressure reduction phase 30. Accordingly, the pressure course 21 shown in the graph below is established in the coupling chamber 9, 9.1, and this course can again be subdivided into a first pressure increase, corresponding to the preinjection, and an ensuing further pressure increase, which corresponds to the main injection.

In the two graphs below this, identified by reference numerals 22 and 23, respectively, the stroke lengths of the two control valves 8, 10 are shown. From graph 22 it can be seen that via the first control valve 8, the preinjection 25 is controlled and also a portion of the main injection is effected. The main injection occupies a longer period of time, so that the required fuel quantity can be injected into the engine combustion chamber. The nozzle needle stroke in the bottom graph 24 (upper curve) remains constant during the main injection, so that the fuel volume required for combustion can be transported or in other words injected into the combustion chamber only over a longer period of time.

In graph 23, the stroke length of the control part of the second control valve 10 is plotted over the time axis. During the preinjection phase 25, the second control valve 10 remains completely open. Not until toward the end of the main injection does the second control valve 10 close and thus contribute to increasing the injection pressure (see graph 24) toward the end of the main injection. From a comparison of the two graphs 22 and 23 that show the stroke lengths of the control valves 8 and 10, respectively, the course of the injection pressure in graph 24 can be derived, on the condition that the nozzle needle stroke 4 is constant and proceeds as shown and comprises an opening motion at the onset of the preinjection and the opening of the nozzle needle 4 during the main injection over the period of time shown in graph 24.

The triggering of the control valves 8, 10 via the actuator 11 makes an individually feasible definition possible of the onset and end of the preinjection and the main injection, depending on the design of the engine. The pressure buildup phase (boot phase) can be preset individually depending on the application. The injection pressure course can also be significantly increased by targeted triggering of the second control valve 10 toward the end of the main injection.

As already described above, the possibility also exists of setting and varying the diversion rate of excess fuel, to prevent a pressure overload of the injector 1, at an equal-pressure valve 14 which is associated with the outflow region of the second control valve 10.

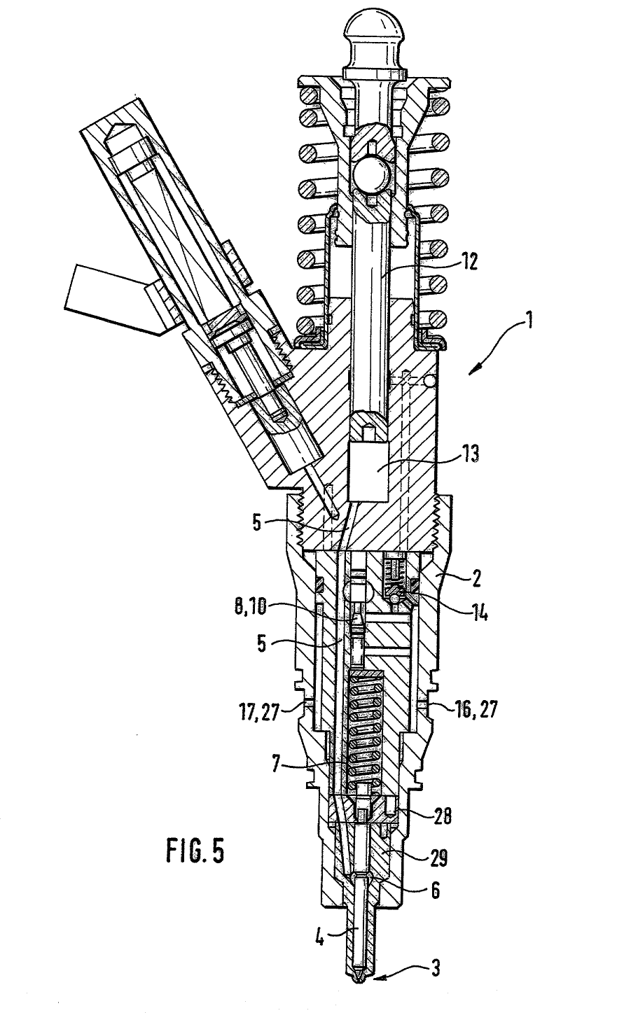

In the view of FIG. 5, an injector of compact structure is shown, in whose injector housing an equal-pressure valve is integrated, the equal-pressure valve being associated with a control valve.

The injector 1 of FIG. 5 includes an injector housing 2, with the piston 12 that protrudes into a pump chamber 13 being let into the upper part of the injector housing. The high-pressure line 5 extends from the pump chamber 13 in the injector housing 2 to the control chamber 6 of a nozzle 3, which can be closed and opened by means of the nozzle needle 4. The nozzle needle 4 in turn is acted upon by a compression spring 7, which is surrounded by the injector housing 2. The control valves 8, 10, only one of which is shown here, are assigned an equal-pressure valve 14, which communicates with the first low-pressure region 16 via the bore 27 in the injector housing 2 and which returns excess fuel, blown off for pressure limitation purposes, back to a supply tank. On the opposite side of the injector housing 2, a bore 27 is provided, by way of which excess fuel can be delivered to a second low-pressure region 17, 16.

In the configuration shown in FIG. 5, the injector housing 2 of the injector 1 is constructed in multiple stages, for example, and centering elements 28 and 29 assure that an arrangement that reduces leakage losses of the components that form the injector housing 2 in the region of the nozzle needles 4 is assured.

List of Reference Numerals

| | |
|---|---|
| 1 | Injector |
| 2 | Injector housing |
| 3 | Nozzle |
| 4 | Nozzle needle |
| 5 | High-pressure supply line |
| 6 | Chamber |
| 7 | Compression spring |
| 8 | First control valve |
| 9 | Coupling chamber |
| 9.1 | Coupling conduit |
| 10 | Second control valve |
| 11 | Piezoelectric actuator |
| 12 | Piston |
| 13 | Pump chamber |
| 14 | Equal-pressure valve |
| 15 | Spring |
| 16 | First low-pressure region |
| 17 | Second low-pressure region |
| 18 | High-pressure bore |
| 19 | Course of actuator stroke |
| 20 | Course of stroke of 12 |
| 21 | Pressure course in coupling chamber |
| 22 | Stroke course of first control valve |
| 23 | Stroke course of second control valve |
| 24 | Injection pressure/nozzle needle stroke |
| 25 | Injection phase |
| 26 | Pressure buildup phase (boot phase) |
| 27 | Housing bore |
| 28 | Centering element |
| 29 | Centering element |
| 30 | Pressure reduction phase |
| 31 | First force storing means (F₁) |
| 32 | Second force storing means (F₂) |

1. A device for injecting fuel with an injector (1), containing a pressure chamber (13), from which a high-pressure supply line (5) extends through an injector housing (2), in which housing a nozzle (3) closable by means of a nozzle needle (4) is disposed, the nozzle needle (4) being acted upon by means of a force storing means (7), characterized in that control valves (8, 10) that are adjustable and triggerable independently of one another via an actuator element (11) are provided and communicate with one another via a coupling chamber (9), with which the injection pressure course (2) can be controlled.

2. The device for injection of claim 1, characterized in that the control valves (8, 10) are switched in succession.

3. The device for injection of claim 1, characterized in that an equal-pressure valve (14) is associated with one of the control valves (8, 10).

4. The device for injection of claim 1, characterized in that a piezoelectric actuator is provided as the actuator element (11).

5. The device for injection of claim 1, characterized in that a throttle element is associated with one of the control valves (8, 10) in the outflow region.

6. The device for injection of claim 1, characterized in that the control valves (8, 10) contain compression spring elements (31, 32), and for the forces that can be generated, the applicable formula is F₂>F₁.

7. The device for injection of claim 1, characterized in that the valve area A₁ of the first control valve (8) is greater than the valve area A₂ of the second control valve (10).

8. The device of claim 1, characterized in that the pressure buildup phase (26) at the nozzle (3) is initiated by triggering of the first control valve (8) into its terminal position.

9. The device of claim 1, characterized in that the main injection is effected by closure of the second control valve (10), which can be moved into the partly-open position to limit the pressure in the pressure chamber (13).

10. The device of claim 9, characterized in that the diversion rate at the injector (1) is adjustable by means of an equal-pressure valve (14).

11. The device of claim 9, characterized in that the relief pressure at the equal-pressure valve (14) is adjustable.

12. The device of claim 9, characterized in that the diversion rate at the injector (1) is adjustable by means of a partial opening of the second control valve (10).
